(19) United States
(12) Patent Application Publication
(10) Pub. No.: US 2024/0412261 A1
(43) Pub. Date: Dec. 12, 2024

(54) VIDEO CHAT INITIATION BASED ON MACHINE LEARNING

(71) Applicant: Loop Now Technologies, Inc., San Mateo, CA (US)

(72) Inventors: Jerry Ting Kwan Luk, Menlo Park, CA (US); Jing Xian Chen, Dublin, CA (US); Edwin Chiu, Cupertino, CA (US)

(73) Assignee: Loop Now Technologies, Inc., San Mateo, CA (US)

(21) Appl. No.: 18/739,394

(22) Filed: Jun. 11, 2024

Related U.S. Application Data
(60) Provisional application No. 63/638,476, filed on Apr. 25, 2024.
(60) Provisional application No. 63/571,732, filed on Mar. 29, 2024.
(60) Provisional application No. 63/557,622, filed on Feb. 26, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/649,966, filed on May 21, 2024.

(51) Int. Cl. G06Q 30/02; G06N 20/00; G06Q 30/0601

(52) U.S. Cl. CPC G06Q 30/0281; G06N 20/00; G06Q 30/0613; G06Q 30/0631; G06Q 30/0643

(57) ABSTRACT

Disclosed embodiments provide techniques for video chat initiation based on machine learning. A website that includes products for sale is accessed. The website is viewed by multiple users. User information is collected and analyzed based on machine learning. The machine learning model is used to predict a purchase intention for a user regarding one or more products for sale. The prediction is based on the machine learning analysis. Information about one or more sales associates is gathered and analyzed based on machine learning. The analysis of sales associate information is used to match a user with a purchase intention with a sales associate. The sales associate can initiate a chat interaction with the user through an overlay on the website. The chat interaction can provide additional user information for the machine learning model. During the chat interaction, the user can purchase one or more products.

### RELATED APPLICATIONS

This application claims the benefit of U.S. provisional patent applications “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

Each of the foregoing applications is hereby incorporated by reference in its entirety.

### FIELD OF ART

This application relates generally to video analysis and more particularly to video chat initiation based on machine learning.

### BACKGROUND

The world of sales and advertising is replete with adages, quotes, and advice from successful salespeople and other experts. “Ask questions first” is one of several popular quotations used to remind sales representatives to form a connection with the customer and to address the customer's needs and desires. While a sales representative often knows more about a product or product category than the customer, it is the customer who must decide whether to buy the product. The customer often wants information based on an understanding they have of a product and its appropriateness to a perceived want or need. The salesperson must address the perceptions of the customer and allow the customer to finally decide whether to buy a particular product.

Another sales adage is “Sales are contingent upon the attitude of the salesperson, not the attitude of the customer.” The job of selling, regardless of the product or service being sold, can be difficult. Salespeople generally hear “No” in some form from a prospective customer much more often than they hear “Yes.” This reality can lead to a sense of failure on the part of the salesperson, and cause hesitation to engage customers, poor attitudes, lethargy, and in some cases, even depression. Many first-time salespeople quit within days of beginning the job. Learning about the product; understanding the options available for products and related services; coordinating purchasing options, shipping, assembly, and instructions for the user; creating demonstrations; and so on can take days, weeks, or even months of time to accomplish. Even after the salesperson has mastered all of this information, the customer can still decide not to purchase the product or service, to purchase a different product instead, to purchase from a different salesperson or vendor, or to simply lose interest in the product and abandon the purchase altogether. Large or complex sales efforts can involve hours of time and many staff people with expertise in multiple areas, and can still end in failure when a customer chooses not to purchase. With these realities in mind, the most successful salespeople work to prepare their own attitudes toward the customer, their product, and the sales process in advance. They actively look for ways to enjoy the process and learn from failures as well as successes. In many cases, they make their focus the customer and the customer's business, rather than promoting themselves or even the product they are attempting to sell. Their value becomes establishing and nurturing a relationship that benefits both parties and seeks success for everyone involved.

A closely related sales adage is “All things being equal, people will do business with, and refer business to, those people they know, like, and trust.” Satisfying human relationships tend to win more sales over time than winner-loser, adversarial, or indifferent relationships. This is true even in the simplest of sales transactions. While price is important, customers tend to return to sales outlets in which the salespeople, customer waitstaff, shop owners, and even the person bagging groceries, sweeping the floor, or pumping gas have pleasant, positive attitudes. Successful restaurant waiters and waitresses work to cultivate all of these qualities, regardless of the type of restaurant they work in. Actively listening to their patrons, remembering what was asked for and delivering it in a timely manner, attending to the needs of the customer, anticipating the customer's needs and providing for them even before they are requested, and genuinely enjoying the act of serving the customer all contribute not only to great tips, but continued customer patronage over time.

### SUMMARY

“Even when you are marketing to your entire audience or customer base, you are simply speaking to a single human at any given time.” As ecommerce digital websites and sales processes have grown across the Internet, the desire for human interaction has not diminished. Customers still want to feel understood, appreciated, and well served by the sales outlets they use to purchase products and services. Just as in a physical store, websites that provide customer service and sales associates who are knowledgeable and efficient, and who exhibit positive attitudes tend to sell more products and services than those who do not. While many transactions require no customer service or salesperson interaction, when the human touch is required, even the most jaded or ruthlessly efficient shopper can be favorably impressed by a ready smile and efficient service from a knowledgeable sales associate.

Disclosed embodiments provide techniques for video chat initiation based on machine learning. A website that includes products for sale is accessed. The website is viewed by multiple users. User information is collected and analyzed based on machine learning. The machine learning model is used to predict a purchase intention for a user regarding one or more products for sale. The prediction is based on the machine learning analysis. Information about one or more sales associates is gathered and analyzed based on machine learning. The analysis of sales associate information is used to match a user with a purchase intention with a sales associate. The sales associate can initiate a chat interaction with the user through an overlay on the website. The chat interaction can provide additional user information for the machine learning model. During the chat interaction, the user can purchase one or more products.

A computer-implemented method for video analysis is disclosed comprising: accessing a website, wherein the website includes one or more products for sale, wherein the website is viewed by a plurality of users; collecting user information, using one or more processors, from the plurality of users viewing the website; analyzing the user information, wherein the analyzing is based on machine learning; predicting a purchase intention, for a user within the plurality of users, of the one or more products for sale, wherein the predicting is based on the analyzing, and wherein the predicting is based on machine learning; matching the user with a sales associate from a plurality of sales associates, wherein the matching is based on the predicting; and initiating an interaction, in an overlay on the website, between the user and the sales associate. Some embodiments comprise updating, from the interaction between the user and the sales associate, the user information. Some embodiments comprise forming a shopper signal, for the sales associate, wherein the shopper signal indicates a probability of a sale by the user, and wherein the shopper signal is based on machine learning. Some embodiments comprise rematching the user with another sales associate, wherein the rematching is based on the collecting, and wherein the rematching is based on machine learning.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for video chat initiation based on machine learning.

FIG. 2 is a flow diagram for initiation of an interaction.

FIG. 3 is an infographic for video chat based on machine learning.

FIG. 4 illustrates prioritizing users.

FIG. 5 shows an example of initiating a video chat session.

FIG. 6 shows an example of inviting a user to a video chat session.

FIG. 7 illustrates updating user information.

FIG. 8 shows an example of an ecommerce environment.

FIG. 9 is a system diagram for video chat initiation based on machine learning.

### DETAILED DESCRIPTION

Ecommerce websites are rapidly becoming the most popular method of purchasing goods and services across the globe. Nearly every product and service imaginable can be found on at least one website somewhere in the world. Even with this unprecedented ecommerce availability, the need for human sales associates and customer service staff remains high. People like to buy products from other people they know, like, and trust. Forming a working connection between a sales associate and a customer greatly increases the chances for a sale both today and in the future. Great customer service gets noticed by social media influencers, product experts, and satisfied customers. Social media platforms are inundated with positive and negative testimonials to either great or terrible purchasing experiences. Whether a customer walks into a clothing boutique or a car dealership, many of the same details of the purchasing process apply. At first, the customer may simply wander around the store or parking lot, glancing at some items, perhaps pausing to look at some more intently, giving others hardly a glance at all. Once in a while, a price might be checked, a sticker read, or a size verified. As the browsing continues, some customers begin to show more interest. An item they already looked at gets a second look, a discussion with someone accompanying them occurs, a dress is held up in front of a mirror, a car is viewed from all sides. The level of interest has increased significantly. Perhaps the customer begins to search for a salesperson. If the salesperson is attentive, he or she is already well aware of the customer. As the browsing has continued, the salesperson has been making an appraisal of their own. The professional salesperson has seen many customers browse before. He or she has come to distinguish real interest from casual glancing. While allowing that they can still be surprised, the salesperson has come to recognize in general what a person can afford, what brands or styles a customer is likely to prefer, and whether anyone accompanying the customer will be helpful or a hindrance to a sale. The observant salesperson knows when to ask the question, “May I be of assistance?” and how to follow it up with just the right answers, advice, and counsel to close a sale.

In much the same way, an ecommerce website can be enhanced to provide a similar level of sales associate interaction and expertise. Techniques for video chat initiation based on machine learning are disclosed. A website that offers products for sale and is visited by multiple users can be accessed by both users and sales associates. As the user navigates through the website, details on their browsing process are collected—which items are they looking at, how long do they linger on them, what details do they examine? Is the customer interested in a particular brand? Are they focusing on a specific type of item? Are they looking for a specific pattern, color, or fabric? Does the price seem to matter a great deal or is it even a factor? Each piece of information generated by a user can be collected and analyzed by a machine learning model which is doing the same for every user visiting the website. Some users simply glance at a few items and leave as quickly as they came. Others linger and start to dig into more details. Short-form videos related to some products are viewed, questions or comments about products are reviewed, and financing options are inspected. As these details are collected, the machine learning model can add in additional information from other sources. User IDs related to the one used to access the website can be found and researched. Items purchased from other stores, alternate website searches, videos viewed on other sites, chats on social media sites, and so on can be added to the user's profile to form a broader and more detailed picture of the potential customer. For some users, the level of interest in a particular product or category becomes significant enough to notify a sales associate. The sales associate is chosen by the machine learning model to match the user's interests, both in the product and more broadly. The sales associate ideally knows about the product the user is interested in, and about other facets of the user's online experience. The sales associate can view the information that the machine learning model has gathered before approaching the user. When the time is right, the sales associate can use an overlay built into the website to come to the same point as would a salesperson in a dress shop or a car dealership. They can electronically ask the question, “May I help you?” Further, with the help of the machine learning model, they can respond with the right answers, counsel, and advice to close the sale.

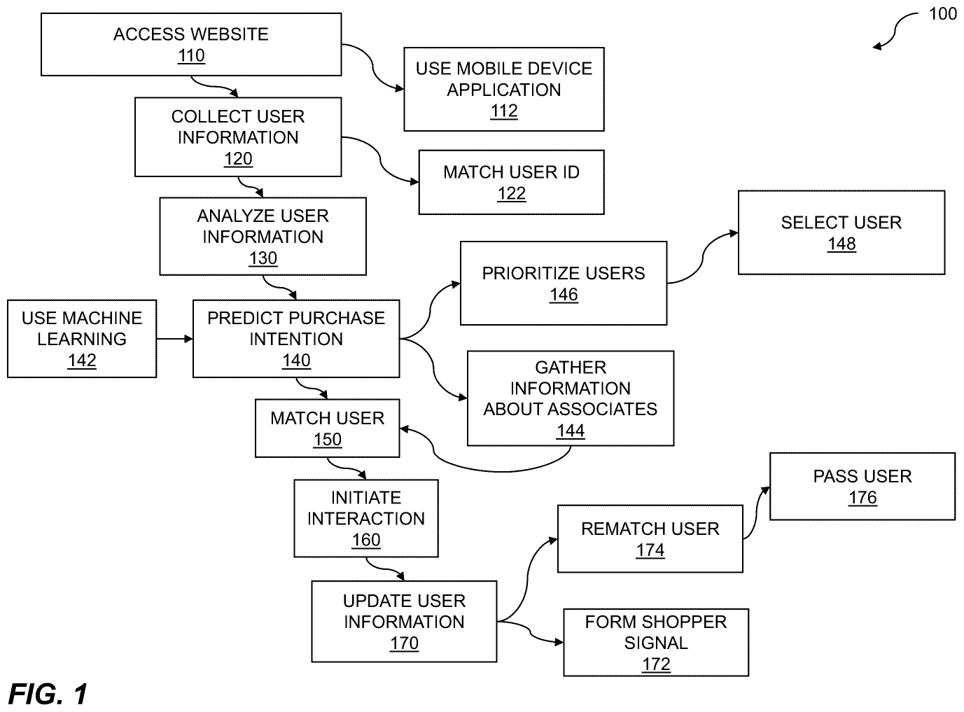

FIG. 1 is a flow diagram for video chat initiation based on machine learning. The flow 100 includes accessing a website 110, wherein the website includes one or more products for sale, wherein the website is viewed by a plurality of users. In embodiments, websites can be accessed by administrators, managers, programmers, sales representatives, and other staff working to maintain and configure the website. The staff members access the site with user IDs and passwords that grant elevated access to control panels, programming tools, product inventory, and so on. In some embodiments, the website host service maintains separate access portals for web administration and programming. Staff members with elevated access can use a standard web browser running on a mobile phone, pad, tablet, laptop, or desktop computer system. In some embodiments, website programmers run development applications on their local workstations in addition to tools embedded in the website host platform. Website users can view the website using a connected television (CTV). A connected television (CTV) is any television set connected to the Internet. CTVs are most commonly used to stream videos. As well as smart TVs with built-in internet connectivity, CTVs can include televisions connected to the Internet via set-top boxes, TV sticks, and gaming consoles. Connected TVs can also include Over-the-Top (OTT) video devices or services accessed by a laptop, desktop, pad, or mobile phone. Content for television can be accessed directly from the Internet without using a cable or satellite set-top box. Any of these devices or services can be used to access websites for ecommerce, viewing videos, watching livestreams, etc. Participants in a video chat can respond to polls, ask questions, make comments, and purchase products for sale that are highlighted during the video chat. The flow 100 includes using a mobile device application 112 to access the website data directly. The website can provide access to a database that includes one or more products for sale. The database can provide support for the mobile device application. The mobile device application can be viewed by a plurality of users, each with a mobile device running the mobile device application. The mobile device application can be implemented in software, in hardware, in a combination of software and hardware, and so on. The mobile devices can include a smart phone, a tablet, a laptop computer, and so on. The software can include preloaded mobile device applications, such as browsers, along with customized ecommerce applications tailored for mobile device use. The mobile device application can be used to access the database directly, rather than using a mobile device browser to view the website. In embodiments, the user views a database supporting the website directly on a mobile device application.

The flow 100 includes collecting user information 120, using one or more processors, from the plurality of users viewing the website. In embodiments, the user information can include website history, chat text, voice interaction, or video usage information. Natural Language Processing (NLP) systems can be used to capture and analyze spoken and written language and extract key information regarding product interests and preferences. As users log onto a website, the user ID of the user can be associated with actions taken as web pages are viewed and interactions with the pages progress. Timers can record the amount of time spent on pages, the number of products on a page investigated for more specific information, the product categories explored, short-term videos watched, products placed in virtual sales carts for purchases, and so on. Information provided by the user when purchases are made, including shipping locations, preferred payment methods, sizes, colors, patterns, and so on, can be stored. Items that are selected for purchase and later exchanged for different products, or removed and not replaced, can be recorded as well. Questions and comments made to online support staff or sales representatives, product evaluations and reviews, complaints, and so on can all be stored, associated with the user ID, and used to build a profile of the user for analysis. The user information can include one or more third party sources. Website users who access a site via a search engine can have their search profile and associated information passed on to the website. The website user ID of the user can be matched 122 with a user ID from one or more third party sources. Internet users with social media profiles can pass on attributes and data points from their user profiles to the websites they use for ecommerce, video viewing, and so on. Associations between user IDs on various sites can be recorded and used to gain additional data from third party websites to broaden a user profile and gain insight into purchase preferences, patterns, demographic information, tastes, lifestyle choices, and so on. All of this data, or select portions of the available data, can be added to an ecommerce website or social media platform database for analysis by a machine learning model.

The flow 100 includes analyzing the user information 130, wherein the analyzing is based on machine learning 142. Machine learning is a technology field of study devoted to understanding and building systems that “learn” based on methods that leverage data to improve computer performance of a set of tasks. Artificial intelligence algorithms are used to imitate the way in which humans learn, and through repetitive uses of datasets, gradually improve performance. Machine learning methodologies can allow computers to improve task performance without explicit human programming after each learning cycle. In embodiments, machine learning algorithms can be used to organize user information to create profiles that can detect interests and predict likely behavior, including intentions to purchase products and services. The data collected from the website, from the user directly, from user performance on the website, and from third party sites and services in which the user participates can be placed into one or more databases that can generate, test, and refine user profiles designed to predict user interests and intentions to purchase products and services.

The flow 100 includes predicting a purchase intention 140, for a user within the plurality of users, of the one or more products for sale, wherein the predicting is based on the analyzing, and wherein the predicting is based on machine learning 142. In embodiments, the predicting includes a purchase intention for each user in the plurality of users. The predicting further comprises prioritizing 146 the plurality of users, wherein the prioritizing is based on the purchase intention that was predicted, further comprising selecting 148, by the sales associate, one user from the plurality of users that was prioritized. Machine learning 142 can be used to predict the purchase intentions 140 of a user while on the website or in the near future, for example, within the next 90 days. In some embodiments, the plurality of users can be segmented into similar groups based on demographics, financial profiles, likelihood to purchase, and so on. In embodiments, the purchase intention comprises information intent, investigative intent, navigational intent, and transactional intent. Informational intent is the lowest level of purchase intention. A user with informational intent is gathering information regarding a product or service, often from multiple sources. For example, data related to a user profile may indicate visits to multiple car dealer websites, car manufacturer websites, local classified advertising, financial institutions, consumer lending platforms, and so on. Machine learning algorithms can be used to predict whether the user has interest in purchasing a new or used car, but without a pattern that indicates a specific car type, brand, or other focus, the purchase intention prediction can remain at an information intention level. The next level of purchase intention is investigative intention. A user at this level is focusing on specific pieces of information from the various sources they have explored and has begun to dig down for more details. For example, a user searching for car information can narrow searches to a few specific models, brands, body styles, etc. Car loan rates and terms can be gathered, along with information about dealer or manufacturer sales or other financial incentives. Trade-in estimates from car research sites or dealer websites can be accessed, and so on. At this point, the user has moved from simply gathering information to investigating specific options for purchasing a vehicle. The next level of purchasing intent is navigational intent. Navigational intent is marked by one or more user search queries that name a specific website or webpage. These specific search queries or navigations to specific websites can indicate that a user has refined their interests to chosen vendors, dealers, ecommerce sites, and so on. For example, a user can type in the web address of a specific bank or credit union, a particular car dealership, a classified ad, and so on. At this point, the user has narrowed their intention to purchase a vehicle to a specific car, from a specific dealer or private owner, to be financed through a specific financial institution. The highest level of user intent is transactional intent. Transactional search queries or web commands are used to complete a purchase of a product or service. This can include securing a car loan on a bank website, submitting a car loan application on a car dealer website, transferring money to a private owner, electronically signing a title, and so on. The user has now made the decision to purchase a vehicle and has initiated the transactions necessary to complete the purchase. Data relating to user interests at varying levels can be included in the machine learning model and used to generate likely purchase intentions for users as they navigate a website and view information about products. The strength of the predicted user purchase intent can be used to sort groups of users so that a user most likely to complete a purchase of one or more products is prioritized for sales associates, as described below.

The flow 100 further comprises gathering information about the plurality of sales associates 144. The sales associate information can include product and sales expertise, hobbies, appearance, conversion rate, tone, style, and so on. The information on sales associates can be gathered directly from the associates themselves, from their actions on the website, and from third party sites associated with their user IDs. Sales conversion rates, areas of product expertise, demographic information, appearance, and so on can be gathered directly from the website and added to the machine learning model 142. The machine learning model can consider actual sales completed by users who interact with particular sales associates and build profiles of users most likely to purchase products from specific sales associates. User interests can be matched to sales associate interests, hobbies, demographics, and so on to build rapport between users and associates quickly and increase the likelihood of product sales and market share for the website. The flow 100 includes matching the user 150 with a sales associate from a plurality of sales associates, wherein the matching is based on the predicting. In embodiments, the matching is based on the gathering information, and the matching is further based on machine learning. As user purchase intentions are analyzed, the users with the highest likelihood of purchasing a product can be matched with sales associates who match the users' interests, as well as having product knowledge for the items the user wants to buy. This increases the chance of the user completing the purchase. Users gathering information or focusing more specifically to investigate particular brands or types of products can be matched with sales associates who have strong corresponding product or brand knowledge, and so on.

The flow 100 includes initiating an interaction 160, in an overlay on the website, between the user and the sales associate. In embodiments, the interaction comprises a text chat, voice call, or video chat. After a sales associate has been matched to a user, the sales representative can be notified and given details regarding the user and the products or services the user is investigating. The sales associate can then initiate contact with the user through the website. In embodiments, a pop-up text chat box on the website, a voice chat prompt, or a phone call, based on user preference, can be generated by the sales associate. The contact can include a request to initiate a video chat, based on user response to the initial contact. In some embodiments, based on the user's preference, the video chat can include the sales associate only. A natural language processor (NLP) built into the website and linked to the machine learning model can record and analyze questions and comments made by the sales associate and user. The NLP data can be used to update the sales associate profile, the user profile, and purchase intention information about the user. The video chat can allow the sales associate to use visual as well as verbal messages to interact with the user, increasing the likelihood of greater user product interest and sales decisions. The video chat can comprise showing, by the sales associate, information about the one or more products for sale; playing, by the sales associate, a short-form video to highlight the one or more products for sale; demonstrating, by the sales associate, the one or more products for sale; and inviting, to the video chat, one or more additional users from within the plurality of users, wherein the inviting is based on the analyzing. Based on user preferences, adding other interested website users can increase the likelihood of decisions to purchase products. Group participation in product demonstrations and reactions to short-form videos can lead to greater interest in products. Chat questions and comments can help maintain user engagement and can lead to discussions of additional products related to the product being displayed. In some embodiments, group video chats can be recorded and played back at a later time, form the basis of a livestream event, or be presented on third party sites as a way of marketing products on additional web platforms.

In embodiments, the interaction further comprises enabling, within the video chat, an ecommerce purchase of the one or more products for sale. As the video chat between the sales associate and the user proceeds, an ecommerce environment is rendered to allow the user to make purchases. The ecommerce purchase includes a virtual purchase cart, further comprising displaying, within the video chat, the virtual purchase cart. The virtual purchase cart can cover a portion of the video chat. In embodiments, the rendering includes a product card. The product card represents at least one product available for purchase while the video chat short-form video plays. Embodiments can include inserting a representation of the first product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or another suitable user action. The product card can be inserted when the video chat is visible in the video chat event. When the product card is invoked, an in-frame shopping environment is rendered over a portion of the video while the video continues to play. This rendering enables an ecommerce purchase by a user while preserving a continuous video playback session. In other words, the user is not redirected to another site or portal that causes the video playback to stop. Thus, viewers are able to initiate and complete a purchase entirely inside of the video playback user interface, without being redirected from the currently playing video or ongoing video chat. Allowing the video chat to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

In embodiments, the sales associate can highlight products and services for sale during the video chat. The sales associate can demonstrate, endorse, recommend, and otherwise interact with one or more products for sale. An ecommerce purchase of at least one product for sale can be enabled to the user, wherein the ecommerce purchase is accomplished within the video chat window. As the host interacts with and presents the products for sale, a product card can be included within a video chat shopping window. An ecommerce environment associated with the video chat event can be generated on the viewer's mobile device or other connected television device as the event progresses. The ecommerce environment on the viewer's mobile device can display the video chat and the ecommerce environment at the same time. The mobile device user can interact with the product card to learn more about the product with which the product card is associated. While the user is interacting with the product card, the video chat continues to play. Purchase details of the at least one product for sale are revealed, wherein the revealing is rendered to the viewer. The viewer can purchase the product through the ecommerce environment, including a virtual purchase cart. The viewer can purchase the product without having to “leave” the video chat. Leaving the video chat can include having to disconnect from the chat, open an ecommerce window separate from the video chat, and so on. The video chat can continue while the viewer is engaged with the ecommerce purchase. In embodiments, the video chat can continue “behind” the ecommerce purchase window, where the virtual purchase window can obscure or partially obscure the video chat.

The flow 100 further comprises updating 170, from the interaction between the user and the sales associate, the user information. In embodiments, the user information includes website history, chat text, voice interaction, or video information. The user information includes implicit information, wherein the implicit information is gathered by the sales associate. Third party information can be added as additional user ID or website associations are revealed by the user or discovered by the machine learning model. As the video chat proceeds, the machine learning database can be updated with information from the user and the sales associate. Questions and comments made by the user can be recorded and analyzed by an NLP system embedded in the website. Mouse clicks generated by the user on website pages can reveal interest in products and services, short-form videos, and so on. Mouse clicks or browses of web pages not related to the product being discussed by the sales associate can also indicate diminishing interest of the user. The sales associate can add implicit information noticed as the video chat progresses. Demographic information such as age, hair color, general appearance, and so on can be added to the user profile. Increasing or decreasing interest in the products being presented can be added based on eye contact, vocal inflections, questions and comments from one or more users, and so on. The updating of the user information further comprises forming a shopper signal 172, for the sales associate, wherein the shopper signal indicates a probability of a sale by the user, and wherein the shopper signal is based on machine learning. The sales associate can add an estimate of the user's likelihood of purchasing one or more items as the video chat continues. The machine learning model can add the estimate to the rest of the user information and generate a shopper signal to the sales associate. In embodiments, the shopper signal can be a numeric score; a percentage; or another form of verbal, text, or visual indication to the sales associate that a purchase is imminent, that a product has been added to a virtual purchase cart, that the user's interest in a product has increased or decreased, and so on.

The updating 170 user information further comprises rematching the user 174 with another sales associate, wherein the rematching is based on the collecting, and wherein the rematching is based on machine learning. In some embodiments, the rematching the user 174 can pass the user 176 to another sales associate based on machine learning. As the video chat progresses and user information is updated, the sales associate can determine that another associate with better knowledge of a particular product line or application of a product can be a better match for the user. The machine learning model 142 can also determine that a different sales associate has a higher likelihood of completing a purchase with a particular user. The machine learning model can generate an indicator to the sales associate hosting the video chat that another associate is available. The sales associate hosting the chat can then ask the user whether they would be interested in working with the alternate associate, or in some embodiments, and can add the alternate associate to the video chat. The sales associate can then pass the user to the alternate sales associate or add the associate to the ongoing video chat. Adding or moving the user to an alternate sales associate can enhance the user experience, maintain or increase engagement, and increase the likelihood of product sales and market share.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

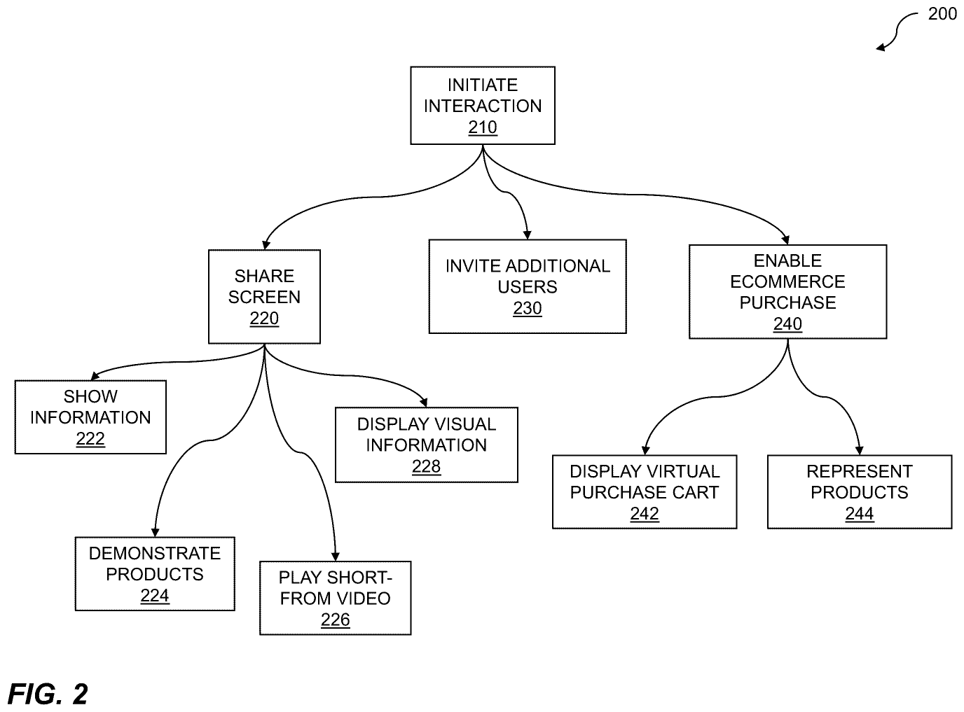

FIG. 2 is a flow diagram for initiation of an interaction. As mentioned above and throughout, a website that includes one or more products for sale can be accessed by a plurality of users and sales associates. User information is collected using one or more processors as the users interact with the website. Additional information about the users can be collected from third party sites based on additional user IDs and other associated data about the user. The collected user information is analyzed using a machine learning model and a purchase intention is predicted for each user based on their actions on the website, purchase history, and other user data elements. Based on the purchase intentions of the users, a sales associate is matched to users who are most likely to purchase items from the website. Information about the sales associate is used by the machine learning model in the matching process. The sales associate can view information about the users and select one with whom to interact in order to provide additional product information and motivate the user toward purchasing one or more products for sale.

The flow 200 includes initiating an interaction 210, in an overlay on the website, between the user and the sales associate. In embodiments, the interaction can be a text chat or voice call. The invitation to chat with the sales associate can appear as a question mark or other icon on the website page the user is viewing. In some embodiments, a sound can accompany the chat invitation. The invitation to start a voice call can also appear on the webpage the user is viewing. The invitation to a voice call can include a phone number for the user or a request for a phone number the user would prefer to use for the interaction. The sales associate can initiate the interaction with the user based on expressed preferences recorded by the user or with default settings. The initial interaction with the user can be a question such as, “Is there anything I can help you with?” or “Would you like more information on this product?”, and so on. The invitation to chat or receive a phone call can include an option to decline the invitation. The reply to a “decline” response can include an explanation to the user on how to initiate an interaction with a sales associate at a later time.

The sales associate can initiate a video chat interaction with the user. In embodiments, the sales associate can add video to an existing text chat with the user or initiate a video chat with a user as they are interacting by voice call. The advantages of a video chat include higher engagement by the user. Opportunities to share the sales associate's screen 220 with the user include showing information 222 about one or more products; demonstrating one or more products 224; playing short-form videos 226 related to the product; displaying photos, graphics, and other visual information 228 related to a product; and so on. A video chat can also allow the user to share their screen with the sales associate. This can be useful in cases where the user is attempting to purchase household items such as furniture, garden plants, clothing, and so on. The sales associate can view and offer suggestions regarding products that would be beneficial to the user based on their situation, and so on. In some embodiments, the video chat can show only the sales associate. There can be many reasons that the user does not prefer to present video from their device. The sales associate can accommodate the user preferences and can continue to interact and present information about the product to the user. A natural language processor (NLP) built into the website and linked to the machine learning model can record and analyze questions and comments made by the sales associate and user during the video chat. The NLP data can be used to update the sales associate profile, the user profile, and the purchase intention information about the user. The video chat can allow the sales associate to use visual as well as verbal messages to interact with the user, increasing the likelihood of greater user product interest and sales decisions.

The flow 200 includes enabling, within the video chat, an ecommerce purchase 240 of the one or more products for sale. The ecommerce purchase 240 includes a virtual purchase cart, further comprising displaying, within the video chat, the virtual purchase cart 242. The virtual purchase cart can cover a portion of the video chat. In embodiments, the rendering includes a product card. The product card represents 244 at least one product available for purchase while the video chat short-form video plays. Embodiments can include inserting a representation of the first product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card can be inserted when the video chat is visible in the video chat window. When the product card is invoked, an in-frame shopping environment is rendered over a portion of the video chat while the video chat continues. This rendering enables an ecommerce purchase by a user while preserving a continuous video chat session. In other words, the user is not redirected to another site or portal that causes the video chat to stop. Thus, viewers are able to initiate and complete a purchase completely inside of the video playback user interface, without being redirected from the currently playing video or ongoing video chat. Allowing the video chat to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The flow 200 includes inviting 230, to the video chat, one or more additional uses from within the plurality of users, wherein the inviting is based on analyzing user information during the video chat. In embodiments, the video chat interaction between the user and sales associate starts a cycle of collecting additional information about the user and the associate, updating the machine learning model database with the additional user and sales associate information, analyzing the additional user information using the machine learning model, and updating the purchase intention of the user based on the predicting component of the machine learning model. As the purchase intentions of the user are updated, the sales associate can be notified of the machine learning model predictions and can respond to the user in order to increase the likelihood of a purchase by the user. A natural language processor (NLP) built into the website and linked to the machine learning model can record and analyze questions and comments made by the sales associate and user. The NLP data can be used to update the sales associate profile, the user profile, and the purchase intention information of the user. The video chat can allow the sales associate to use visual and verbal messages to interact with the user, increasing the likelihood of greater user product interest and sales decisions. Based on user preference and product interest analysis by the machine learning model, adding interested website users to a video chat can increase the likelihood of decisions to purchase products. Group participation in product demonstrations and reactions to short-form videos can lead to greater interest in products. Chat questions and comments can help maintain user engagement and can lead to discussions of additional products related to the product being displayed. In some embodiments, group video chats can be recorded and played back at a later time, can form the basis of a livestream event, or can be presented on third party sites as a way of marketing products on additional web platforms.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

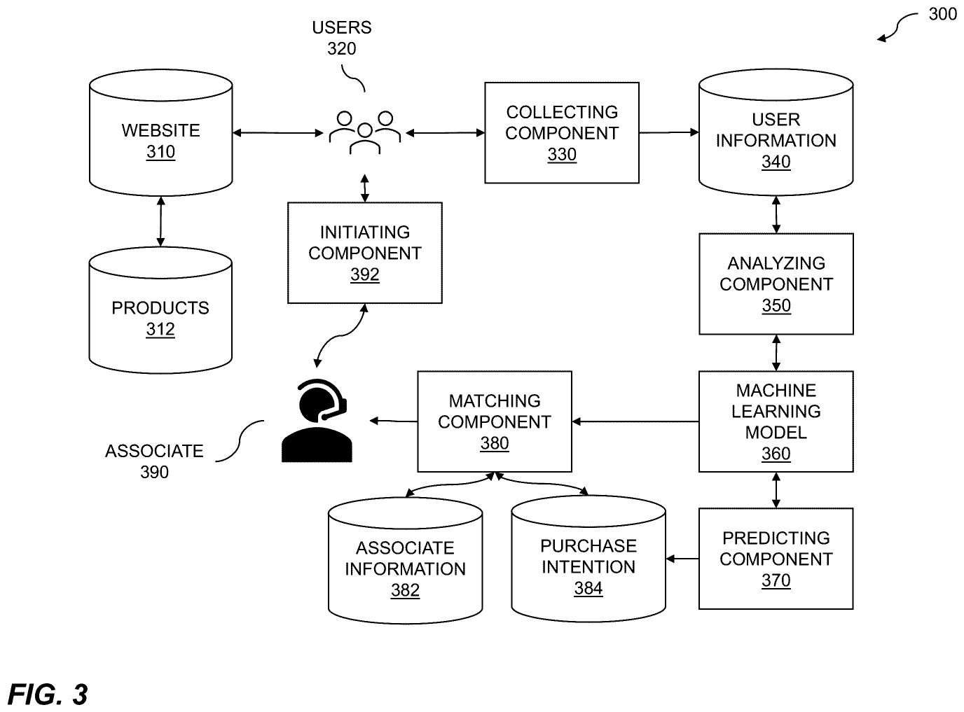

FIG. 3 is an infographic for video chat initiation based on machine learning. The infographic 300 includes accessing a website 310, wherein the website includes one or more products for sale 312, wherein the website is viewed by a plurality of users 320. In embodiments, the website 310 can be accessed by administrators, managers, programmers, sales representatives, and other staff working to maintain and configure the website. The staff members can access the site with user IDs and passwords that grant elevated access to control panels, programming tools, product inventory, and so on associated with the website. In some embodiments, the website hosting service can provide separate access portals for web administration and programming. Website users 320 can view the website using a connected television (CTV). A connected television (CTV) is any television set connected to the Internet. CTVs are most commonly used to stream videos. As well as smart TVs with built-in internet connectivity, CTVs can include televisions connected to the Internet via set-top boxes, TV sticks, and gaming consoles. Connected TVs can also include Over-the-Top (OTT) video devices or services accessed by a laptop, desktop, pad, or mobile phone. Information on products and services offered for sale on the website can be stored in one or more databases containing details on each product, including sizes, colors, dimensions, shipping information, pricing, and so on. Inventory details can be included as well. In some embodiments, products that are stored in multiple warehouse or store locations can be linked to the address of a user making a purchase so that a purchased item is shipped from the location nearest to the user.

The infographic 300 includes a collecting component 330. The collecting component 330 can collect user information 340, using one or more processors, from the plurality of users 320 viewing the website 310. In embodiments, the user information can include website history, chat text, voice interaction, or video usage information. Natural Language Processing (NLP) systems can be used to capture and analyze spoken and written language and extract key information regarding product interests and preferences. As users 320 log onto a website 310, the user ID of the user can be associated with actions taken as web pages are viewed and interactions with the pages occur. The time spent on pages, products on a page investigated for more specific information, product categories explored, short-term videos watched, products placed in virtual sales carts for purchases, and so on can be collected. Information provided by the user when purchases are made can be collected, including shipping locations, preferred payment methods, sizes, colors, patterns, and so on. Items that are selected for purchase and later swapped for different products or removed and not replaced can be collected as well. Questions and comments made to online support staff or sales representatives, product evaluations and reviews, complaints, and so on can all be collected, associated with the user ID, and aggregated to build a profile of the user for analysis. The user information 340 can include one or more third party sources. Website users who access a site via a search engine can have their search profile and associated information passed on to the website. The website user ID of users 320 can be matched with a user IDs from one or more third party sources. Internet users with social media profiles can pass on attributes and data points from their social media user profiles to websites used for ecommerce, video viewing, and so on. Associations between user IDs on various sites can be collected and used to gain additional data from third party websites to broaden a user information profile and gain insight into purchase preferences, patterns, demographic information, tastes, lifestyle choices, and so on. All of this data, or select portions of the available data, can be added to an ecommerce website or social media platform database for analysis by a machine learning model.

The infographic 300 includes an analyzing component 350. The analyzing component 350 can analyze the user information 340, wherein the analyzing is based on a machine learning model 360. In embodiments, machine learning models can be used to organize user information to create profiles that can detect interests and predict likely behavior, including intentions to purchase products and services. The data collected from collecting component 330 from the website, from the user directly, from user performance on the website, and from third party sites and services in which the user participates can be placed into one or more databases that can used by a machine learning model 360 to generate, test, and refine user profiles designed to predict user interests and intentions to purchase products and services. In embodiments, there are many different machine learning algorithms available to predict customer purchase behavior, including random forest tree, artificial neural network, support vector machine, K-nearest neighbor, naive Bayes, logistic regression, dummy classifier, stochastic gradient descent, and hybrid algorithms.

The infographic 300 includes a predicting component 370. The predicting component 370 can predict a purchase intention, for a user within the plurality of users, of the one or more products for sale, wherein the predicting is based on the analyzing, and wherein the predicting is based on machine learning. In some embodiments, logistic regression can be used to develop a machine learning model 360. In a logistic regression machine learning model, the goal is to predict the probability of a certain outcome, such as a customer making a purchase, based on input variables that can include age, location, and so on. In embodiments, the predicting includes a purchase intention 384 for each user in the plurality of users. The predicting further comprises prioritizing the plurality of users 320, wherein the prioritizing is based on the purchase intention that was predicted, further comprising selecting, by the sales associate, one user from the plurality of users that was prioritized. The machine learning model can be used to predict the purchasing intentions of a user while on the website or in the near future, for example, within the next 90 days. In some embodiments, the plurality of users can be segmented into similar groups based on demographics, financial profiles, likelihood to purchase, and so on. As described above and throughout, the purchase intention 384 comprises information intent, investigative intent, navigational intent, and transactional intent. Data relating to user interests at varying levels can be included in the machine learning model and used to predict likely purchase intentions for users as they navigate through a website and view information about products. The strength of the predicted user purchase intent can be used to sort groups of users so that a user most likely to complete a purchase of one or more products is prioritized for sales associates, as described below.

The infographic 300 includes a matching component 380. The matching component can match the user with a sales associate from a plurality of sales associates, wherein the matching is based on the predicting. In embodiments, the matching further comprises gathering information about the plurality of sales associates. The sales associate information can include product and sales expertise, hobbies, appearance, conversion rate, tone, style, and so on. The information on sales associates can be gathered directly from the associates themselves, from their actions on the website, and from third party sites associated with their user IDs. Sales conversion rates, areas of product expertise, demographic information, appearance, and so on can be gathered directly from the website and added to the machine learning model 360. The machine learning model can consider actual sales completed by users who interact with particular sales associates and build profiles of users most likely to purchase products from specific sales associates. User interests can be matched to sales associate interests, hobbies, demographics, and so on to build rapport between users and associates quickly and increase the likelihood of product sales and market share for the website. The matching of users 320 to sales associates 390 is based on the user information 340, sales associate information 382, and the predicted purchase intention 384 of one or more users 320, wherein the matching is based on a machine learning model 360. As user purchase intentions are analyzed 350, the users with the highest likelihood of purchasing a product can be matched with sales associates 390 who share the users' interests, and who have product knowledge for the items the user wants to buy. This increases the chance of the user completing the purchase. Users gathering information or focusing more specifically to investigate particular brands or types of products can be matched with sales associates who have strong corresponding product or brand knowledge, and so on.

The infographic 300 includes an initiating component 392. The initiating component 392 can initiate an interaction, in an overlay on the website 310, between the user 320 and the sales associate 390. In embodiments, the interaction comprises a text chat, voice call, or video chat. After a sales associate has been matched to a user, the sales representative can be notified and given details regarding the user and the products or services the user is investigating. The sales associate can then initiate a contact with the user through the website. In embodiments, a pop-up text chat box on the website, a voice chat prompt, or a phone call, based on user preference, can be generated by the sales associate. The contact can include a request to initiate a video chat based on user response to the initial contact. In some embodiments, based on the user's preference, the video chat can include the sales associate only.

In embodiments, the initiating component further comprises enabling, within the video chat, an ecommerce purchase of the one or more products for sale. As the video chat between the sales associate and the user proceeds, an ecommerce environment is rendered to allow the user to make purchases. The ecommerce purchase includes a virtual purchase cart, further comprising displaying, within the video chat, the virtual purchase cart. The virtual purchase cart can cover a portion of the video chat. In embodiments, the rendering includes a product card. The product card represents at least one product available for purchase while the video chat short-form video plays. Embodiments can include inserting a representation of the first product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card can be inserted when the video chat is visible in the video chat event. When the product card is invoked, an in-frame shopping environment is rendered over a portion of the video while the video continues to play. This rendering enables an ecommerce purchase by a user while preserving a continuous video playback session. In other words, the user is not redirected to another site or portal that causes the video playback to stop. Thus, viewers are able to initiate and complete a purchase completely inside of the video playback user interface, without being redirected from the currently playing video or ongoing video chat. Allowing the video chat to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

In embodiments, the initiating component initiates a cycle of collecting additional information about the user and the associate, updating the user information database and the sales associate information, analyzing the additional user information using the machine learning model, and updating the purchase intention of the user based on the predicting component of the machine learning model. As the purchase intentions of the user are updated, the sales associate can be notified of the machine learning model predictions and can respond to the user, increasing the likelihood of a purchase by the user. A natural language processor (NLP) built into the website and linked to the machine learning model can record and analyze questions and comments made by the sales associate and user. The NLP data can be used to update the sales associate profile, the user profile, and the purchase intention information about the user. The video chat can allow the sales associate to use visual as well as verbal messages to interact with the user, increasing the likelihood of greater user product interest and purchase decisions. The video chat can comprise showing, by the sales associate, information about the one or more products for sale; playing, by the sales associate, a short-form video to highlight the one or more products for sale; demonstrating, by the sales associate, the one or more products for sale; and inviting, to the video chat, one or more additional users from within the plurality of users, wherein the inviting is based on the analyzing. Based on user preferences, adding other interested website users can increase the likelihood of decisions to purchase products. Group participation in product demonstrations and reactions to short-form videos can lead to greater interest in products. Chat questions and comments can help maintain user engagement, and can lead to discussions of additional products related to the product being displayed.

In embodiments, the updated user information includes website history, chat text, voice interaction, or video information. The user information includes implicit information, wherein the implicit information is gathered by the sales associate. Third party information can be added as additional user ID or website associations are revealed by the user or discovered by the machine learning model. As the video chat proceeds, the machine learning database can be updated with information from the user and the sales associate. The sales associate can add implicit information noticed as the video chat progresses. Demographic information such as age, hair color, general appearance, and so on can be added to the user profile. Increasing or decreasing interest in the products being presented can be added based on eye contact, vocal inflections, questions, and comments from one or more users, and so on. The updating of the user information further comprises forming a shopper signal, for the sales associate, wherein the shopper signal indicates a probability of a sale by the user, and wherein the shopper signal is based on machine learning. The sales associate can add an estimate of the user's likelihood of purchasing one or more items as the video chat continues. The machine learning model 360 can add the estimate to the rest of the user information and generate a shopper signal to the sales associate. In embodiments, the shopper signal can be a numeric score; a percentage; or another form of verbal, text, or visual indication to the sales associate that a purchase is imminent, that a product has been added to a virtual purchase cart, that the user's interest in a product has increased or decreased, and so on.

In some embodiments, the updating of user information further comprises rematching the user with another sales associate, wherein the rematching is based on the collecting, and wherein the rematching is based on machine learning. The rematching the user 320 can pass the user to another sales associate 390 based on machine learning. As the video chat progresses and user information is updated, the sales associate 390 can determine that another sales associate with better knowledge of a particular product line or application of a product can be a better match for the user. The machine learning model can also predict that a different sales associate has a higher likelihood of completing a purchase with a particular user. The machine learning model can generate an indicator to the sales associate hosting the video chat that another associate with a stronger match to the user is available. The sales associate hosting the chat can ask the user whether they would be interested in working with the alternate associate, or in some embodiments, adding the alternate associate to the video chat. The sales associate can then pass the user to the alternate sales associate or add the associate to the ongoing video chat. Adding or moving the user to an alternate sales associate can enhance the user experience, maintain or increase engagement, and increase the likelihood of product sales and market share.

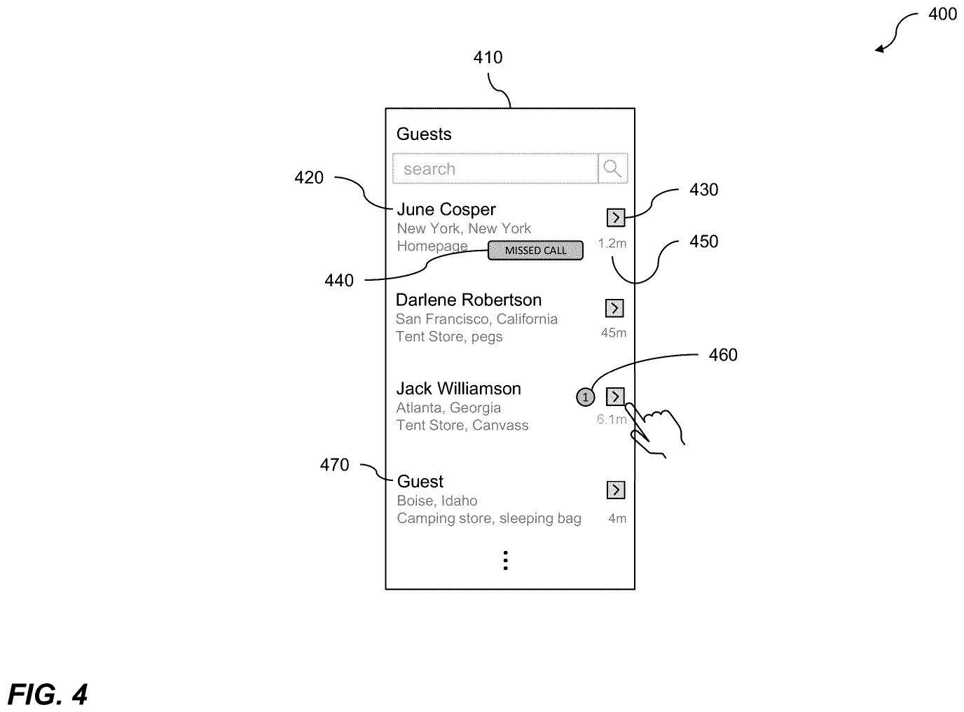

FIG. 4 illustrates prioritizing users. As mentioned above and throughout, a website that includes one or more products for sale can be accessed by a plurality of users and sales associates. User information is collected using one or more processors as the users interact with the website. Additional information about the users can be collected from third party sites based on additional user IDs and other associated data about the user. The collected user information is analyzed using a machine learning model and a purchase intention is predicted for each user based on their actions on the website, purchase history, and other user data elements.

The illustration 400 includes a list of users 410 from the plurality of users viewing the website. A sales associate can be matched with a group of users based on the analysis of a machine learning model. The machine learning model can use information about the user and the sales associate to match one or more users with a sales associate that is most likely to encourage the user to complete a product purchase. In embodiments, the list of users can be prioritized in order of the purchase intention that is predicted by a machine learning model. In some embodiments, the plurality of users viewing the website can be segmented into similar groups based on demographics, financial profiles, likelihood to purchase, and so on. The purchase intention groupings include informational intent, investigative intent, navigational intent, and transactional intent. The groupings represent increasing levels of purchase intent, with informational intent as the lowest level and transactional intent as the highest level. Informational intent is the lowest level of purchase intention. A user with informational intent is simply gathering information regarding a product or service, often from multiple sources. Machine learning algorithms can be used to predict whether the user has interest in purchasing a product, but without a pattern that indicates a specific product, brand, or other focus, the purchase intention prediction remains at an information intention level. The next level of purchase intention is investigative intention. A user at this level is focusing on specific pieces of information from the various sources they have explored and has begun to dig down for more details. For example, a user searching for car information can narrow searches to a few specific models, brands, body styles, etc. Car loan rates and terms can be gathered, along with information about dealer or manufacturer sales or other financial incentives. Trade-in estimates from car research sites or dealer websites can be accessed, and so on.

At this point, the user has moved from simply gathering information to investigating specific options for purchasing a vehicle. The next level of purchasing intent is navigational intent. Navigational intent is marked by one or more user search queries that name a specific website or webpage. For example, specific search queries or navigations to specific websites can indicate that a user has refined their interests to chosen vendors, dealers, ecommerce sites, and so on. At this point, the user has increased their purchase intention to purchase a vehicle to a specific car, from a specific dealer or private owner, to be financed through a specific financial institution. The highest level of user intent is transactional intent. Transactional search queries or web commands are used to complete a purchase of a product or service. This can include, for example, securing a car loan on a bank website, submitting a car loan application on a car dealer website, transferring money to a private owner, electronically signing a title, and so on. The user has now made the decision to purchase a vehicle and has initiated the transactions necessary to complete the purchase. Data relating to user interests at varying levels can be included in the machine learning model and can be used to generate likely purchase intentions for users as they navigate through a website and view information about products. The strength of the predicted user purchase intent can be used to sort groups of users so that a user most likely to complete a purchase of one or more products is prioritized for sales associates.

The illustration 400 includes a user's name 420 and basic information about the user and the user location on the website. This information can be displayed by a sales associate and can be used to personalize an invitation to the user to a text or video chat. In some embodiments, the initial interaction with the user can be a voice call. The information on each user includes the user's name, location, and products for which the user has demonstrated purchase intent. In the illustration 400, the first user, “June Cosper”, has demonstrated a high level of purchase intent by calling the sales associate or customer service number in order to get information about a product for sale. Since the call was not answered, a “MISSED CALL” indicator 440 is displayed near the user's name. To the right of the missed call indicator, the amount of time 450 which the user has spent on the website is indicated. In the FIG. 4 example, June Cosper has been on the website for 1.2 minutes. The additional information under the user's name 420 indicates that the user is on the homepage of the website, possibly waiting for a call back from a sales associate in order to move forward with a purchase or receive answers to questions, etc. To the right of the user's name is a right arrow button 430, allowing the sales associate to initiate an interaction with the user. A chat window allowing both text and video chats can replace the list of users when the sales associate selects a user to contact. In some embodiments, a dialer can replace the list of users if the user has indicated a preference for voice calls as the contact method to be used.

The illustration 400 includes an indicator 460 to allow the sales associate to view additional information about a user. In embodiments, the additional information can include a purchase history for the user, available demographic information, additional products and services viewed by the user, and so on. The additional information can allow the sales associate to better understand and anticipate the user's questions and comments and prepare demonstrations, short-form videos, and other information in order to help the user and increase the likelihood of purchasing products.

The illustration 400 includes a Guest user 470 in the lists of users. In embodiments, users without a user ID on the website can be assigned a temporary guest ID by the website. Information on the user, including purchase intentions, can be collected and analyzed. In some embodiments, additional user information can be collected from third party websites and social media platforms, based on the search method a guest user employs to access the ecommerce website. Depending on the strength of the guest user's purchase intention, the guest user can appear higher on the list of users available for the sales associate to interact with. As the users continue to navigate the website, click on products, add products to virtual shopping carts, view product videos, and so on, the list of users can be updated so that as a sales associate completes an interaction with a user, the remaining users can appear in a different order on the list based on an updated purchase intention ranking.

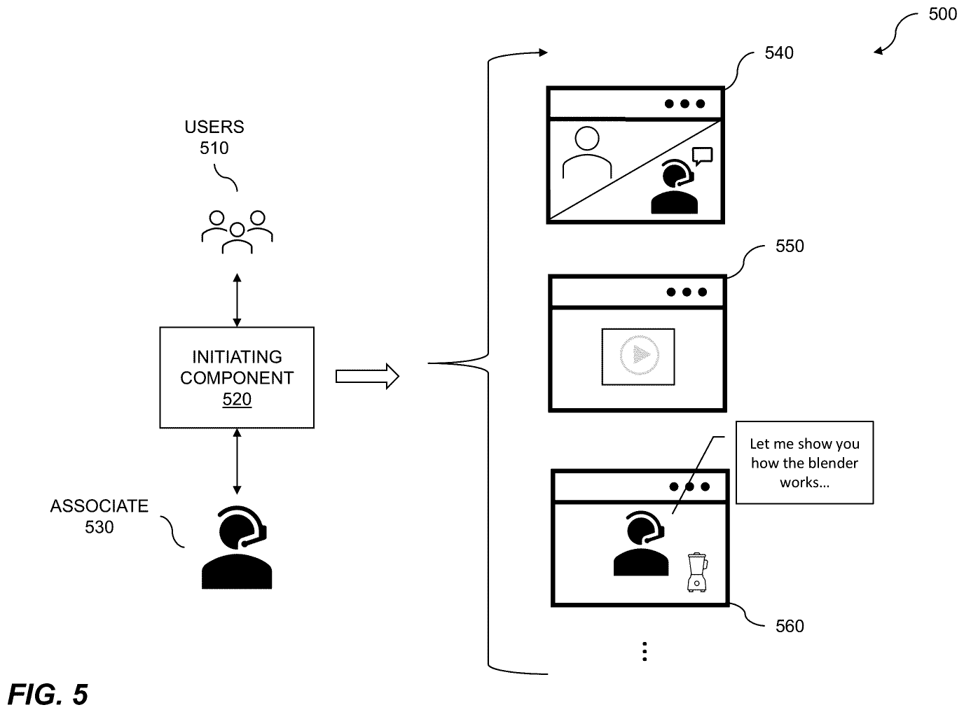

FIG. 5 shows an example of initiating a video chat session. As mentioned above and throughout, a website that includes one or more products for sale can be accessed by a plurality of users and sales associates. User information is collected using one or more processors as the users interact with the website. Additional information about the users can be collected from third party sites based on additional user IDs and other associated data about the user. The collected user information is analyzed using a machine learning model and a purchase intention is predicted for each user, based on their actions on the website, purchase history, and other user data elements. Based on the purchase intentions of the users, a sales associate is matched to users who are most likely to purchase items from the website. Information about the sales associate is used by the machine learning model in the matching process. The sales associate can view information about the users and can select one with whom to interact in order to provide additional product information and motivate the user toward purchasing one or more products for sale.

The example 500 includes an initiating component 520. The initiating component 520 can initiate an interaction, in an overlay on the website, between the user 510 and the sales associate 530. A website overlay is a content box that appears on top of a web page and obscures the background content. An overlay can be used to notify a user of important information, collect information from a user, display advertisements or coupon offers, provide a communication window which can include a chat box or telephone call box, and so on. In embodiments, the interaction between the sales associate and the user can be a text chat or voice call. The invitation to chat with the sales associate can appear as a question mark or other icon on the website page the user is viewing within the overlay. In some embodiments, a sound can accompany the chat invitation to notify the user. The invitation to a voice call can include a phone number for the user or a request for a phone number the user would prefer to use for the interaction. The sales associate can initiate the interaction with the user based on expressed preferences recorded by the user or with default settings. The initial interaction with the user can be a question such as, “Is there anything I can help you with?” or “Would you like more information on this product?”, and so on. The invitation to chat or receive a phone call can include an option to decline the invitation. The reply to a “decline” response can include an explanation to the user on how to initiate an interaction with a sales associate at a later time.

The example 500 includes a video chat interaction 540 with the user. In embodiments, the sales associate can add video to an existing text chat with the user or initiate a video chat 540 with a user as they are interacting by voice call. The advantages of a video chat include higher engagement by the user; opportunities to share the sales associate's screen with the user in order to demonstrate one or more products 560; and opportunities to show photos, graphics, or short-form videos related to the product 550. In FIG. 5, the example 560 shows the sales associate demonstrating a blender in which the user has shown interest.

The video chat 540 can also allow the user to share their screen with the sales associate. This can be useful in cases where the user is attempting to purchase household items such as furniture, garden plants, clothing, and so on. The sales associate can view and offer suggestions regarding products that would be beneficial to the user based on their situation, and so on. In some embodiments, the video chat can show only the sales associate. There can be many reasons that the user does not prefer to present video from their device. The sales associate can accommodate the user preferences and continue to interact and present information about the product to the user. A natural language processor (NLP) built into the website and linked to the machine learning model can record and analyze questions and comments made by the sales associate and user during the video chat. The NLP data can be used to update the sales associate profile, the user profile, and the purchase intention information about the user. The video chat can allow the sales associate to use visual as well as verbal messages to interact with the user, increasing the likelihood of greater user product interest and sales decisions.

The example 500 includes enabling, within the video chat 540, an ecommerce purchase of the one or more products for sale. The ecommerce purchase includes a virtual purchase cart further comprising displaying, within the video chat, the virtual purchase cart. The virtual purchase cart can cover a portion of the video chat. In embodiments, the rendering includes a product card. The product card represents at least one product available for purchase while the video chat short-form video plays. Embodiments can include inserting a representation of the product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card can be inserted when the video chat is visible in the video chat window. When the product card is invoked, an in-frame shopping environment is rendered over a portion of the video chat while the video chat continues. This rendering enables an ecommerce purchase by a user while preserving a continuous video chat session. Viewers are able to initiate and complete a purchase completely inside of the video playback user interface, without being redirected from the currently playing video or ongoing video chat. Allowing the video chat to play during the purchase can enable improved audience engagement, which can lead to additional sales and revenue, one of the key benefits of disclosed embodiments.

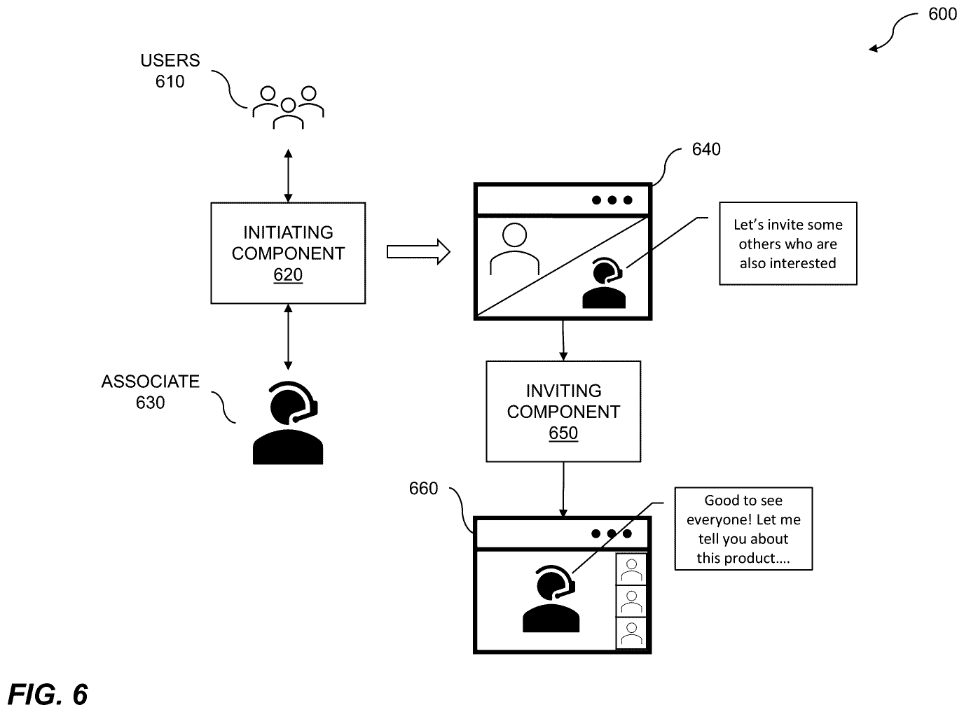

FIG. 6 shows an example of inviting a user to a video chat session. As mentioned above and throughout, a website that includes one or more products for sale can be accessed by a plurality of users and sales associates. User information is collected using one or more processors as the users interact with the website. Additional information about the users can be collected from third party sites based on additional user IDs and other associated data about the user. The collected user information is analyzed using a machine learning model and a purchase intention is predicted for each user, based on their actions on the website, purchase history, and other user data elements. Based on the purchase intentions of the users, sales associates are matched to users who are most likely to purchase items from the website. Information about the sales associate is used by the machine learning model in the matching process. The sales associate can view information about the users and select one with whom to interact in order to provide additional product information and motivate the user toward purchasing one or more products for sale.

The example 600 includes an initiating component 620. The initiating component 620 can initiate an interaction, in an overlay on the website, between the user 610 and the sales associate 630. A website overlay is a content box that appears on top of a web page and obscures the background content. An overlay can be used to notify a user of important information, collect information from a user, display advertisements or coupon offers, provide a communication window which includes a chat box or telephone call box, and so on. In embodiments, the interaction between the sales associate and the user can be a text chat or voice call. The invitation to chat with the sales associate can appear as a question mark or other icon on the website page the user is viewing within the overlay. In some embodiments, a sound can accompany the chat invitation to notify the user. The invitation to a voice call can include a phone number for the user or a request for a phone number the user would prefer to use for the interaction. The sales associate can initiate the interaction with the user based on expressed preferences recorded by the user or with default settings. The initial interaction with the user can be a question such as, “Is there anything I can help you with?” or “Would you like more information on this product?”, and so on. The invitation to chat or receive a phone call can include an option to decline the invitation. The reply to a “decline” response can include an explanation to the user on how to initiate an interaction with a sales associate at a later time.

The example 600 includes a video chat interaction 640 with the user. In embodiments, the sales associate can add video to an existing text chat with the user or initiate a video chat with a user while they are interacting by voice call. The video chat initiated by the initiating component 620 starts a cycle of collecting additional information about the user and the associate, updating an information database with the user and sales associate information, analyzing the additional user information using the machine learning model, and updating a purchase intention of the user based on a predicting component within the machine learning model. As the purchase intentions of the user are updated, the sales associate can be notified of the machine learning model predictions and can respond to the user in order to increase the likelihood of a purchase by the user. The video chat can allow the sales associate to use visual as well as verbal messages to interact with the user, increasing the likelihood of greater user product interest and sales decisions.

In embodiments, as the video chat progresses and the machine learning model analyzes the collected information from the user and sales associate, user information about other users on the website is also being analyzed. The machine learning model can identify additional users with the same or similar purchase intentions to the user participating in the video chat. The machine learning model can prioritize the list of additional users with purchase intentions for the same or similar products to the user in the video chat and can notify the sales associate about the additional users. The sales associate can view the list of additional users and select one or more users to invite to the ongoing video chat. The sales associate can also interact with the user in the video chat and suggest adding more website users with the same or similar purchase intentions. The example 600 shows a suggestion 640 by the sales associate 630 by saying, “Let's invite some others who are also interested.”

The example 600 includes an inviting component 650. The sales associate can use the inviting component 650 to send an invitation to one or more website users and add the users to an ongoing video chat between a sales associate and a user. A website overlay can appear on the webpage that each additional user is viewing, inviting the user to join the video chat related to a product in which they have shown an interest. The website overlay can add the one or more invited users to the video chat based on their selecting an option to join, embedded in the overlay invitation. In embodiments, the machine learning model can determine that inviting additional users to the video chat can increase the likelihood of one or more user decisions to purchase products. Group participation in product demonstrations and reactions to short-form videos can lead to greater interest in products. Chat questions and comments can help maintain user engagement and can lead to discussions of additional products related to the product being displayed. The example 600 shows additional users 660 participating in the video chat along with the original user and the sales associate. In the example 660, multiple users can be seen along with the sales associate. The sales associate is able to interact with all of the users in the video chat by saying, “Good to see everyone! Let me tell you about this product . . . ”

The example 600 includes enabling, within the video chat 660, an ecommerce purchase of the one or more products for sale. The ecommerce purchase includes a virtual purchase cart, further comprising displaying, within the video chat, the virtual purchase cart. The virtual purchase cart can cover a portion of the video chat. In embodiments, the rendering includes a product card. The product card represents at least one product available for purchase while the video chat short-form video plays. Embodiments can include inserting a representation of the product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or another suitable user action. The product card can be inserted when the video chat is visible in the video chat window. When the product card is invoked, an in-frame shopping environment is rendered over a portion of the video chat while the video chat continues. This rendering enables an ecommerce purchase by a user while preserving a continuous video chat session. All users in the video chat 660 are able to initiate and complete a purchase completely inside of the video playback user interface, without being redirected from the currently playing video or ongoing video chat. Allowing the video chat to play during the purchase can enable improved audience engagement, which can lead to additional sales and revenue, one of the key benefits of disclosed embodiments.

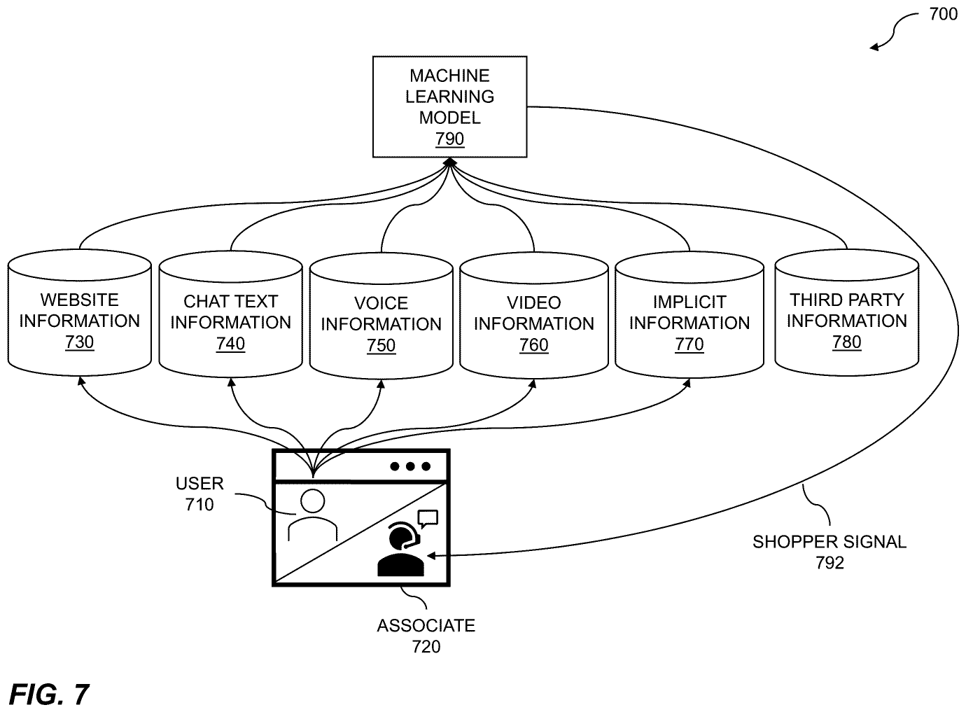

FIG. 7 illustrates updating user information. As described above and throughout, a website that includes one or more products for sale can be accessed by a plurality of users and sales associates. User information is collected using one or more processors as the users interact with the website. Additional information about the users can be collected from third party sites based on additional user IDs and other associated data about the user. The collected user information is analyzed using a machine learning model and a purchase intention is predicted for each user, based on their actions on the website, purchase history, and other user data elements. Based on the purchase intentions of the users, a sales associate is matched to users who are likely to purchase items from the website. Information about the sales associate is used by the machine learning model in the matching process. The sales associate can view information about the users and select one with whom to interact in order to provide additional product information and motivate the user toward purchasing one or more products for sale.

The illustration 700 includes a video chat between a user 710 and a sales associate 720 for a website. In embodiments, the video chat is initiated based on a machine learning model 790 prediction of the user's purchase intention toward one or more products offered for sale on the website. The sales associate 720 is matched with the user 710 based on information gathered about the user and the sales associate. As the user and sales associate interact in the video chat, the machine learning model 790 continues to collect information about the user. The information is used by the machine learning model to update the purchase intention of the user toward purchasing one or more products. As the purchase intention is updated by the machine learning model, a shopper signal 792 can be generated to indicate the probability of a purchase of one or more products by the user. The shopper signal can be presented to the sales associate 720 so that the associate can respond to the user 710 in order to complete the purchase or take additional steps to increase the likelihood of a purchase.

The illustration 700 includes website information 730 as a source of information about the user 710. Website information 730 can include a location for the user based on a street address or zip code; purchase history; shipping preferences; payment sources; comments; questions sent to customer service; webpage browsing history, including products viewed, pages visited, length of time spent on various web pages; and so on. The website information can be used by the machine learning model 790 to predict product interest and interest intensity based on prior history, as well as viewing history in real time.

The illustration 700 includes chat text information 740. The machine learning model can include a natural language processor (NLP) that can record and analyze questions and comments made by the sales associate 720 and user 710. NLP is a category of artificial intelligence (AI) concerned with interactions between humans and computers using natural human language. NLP can be used to develop algorithms and models that allow computers to understand, interpret, generate, and manipulate human language. NLP includes speech recognition; text and speech processing; encoding; text classification, including text qualities, emotions, humor, and sarcasm, and classifying it accordingly; language generation; and language interaction, including dialogue systems, voice assistants, and chatbots. In embodiments, the chat text analyzing includes NLP to understand the text and the context of voice and text communication during the video chat. The NLP can also be used to collect and analyze voice information 750 from the user 710 and sales associate 720. NLP can be used to detect one or more topics discussed by the user 710 and the sales associate 720. Evaluating the chat text information 740 and voice information 750 can include determining one or more topics of discussion during the video chat; understanding references to and information from other chats or websites; determining demographic data; recognizing products for sale or product brands being discussed; and recognizing other sales associates, celebrities, or influencers who work with a brand, product for sale, or topic. NLP can analyze the voice information 750 to predict levels of interest in products, excitement or disappointment related to information discussed, and so on. The NLP data can be used by the machine learning model 790 to update the sales associate profile, the user profile, and the purchase intention information about the user.

The illustration 700 includes video information 760. Ecommerce websites, social media sites, and video platforms provide short-form videos related to many products and services. The short-form videos can include product presentations; commercial advertising; demonstrations; testimonials from celebrities, social media influencers, and product experts; and so on. Information collected as a user views a short-form video can include the amount of time the video is watched; whether the entire video is watched; the number of times the video is watched; questions or comments made by the user as the video plays, stops and restarts, or rewinds; and so on. Metadata associated with the video can include information about the presenter, the product highlighted in the video, the number of times the video has been viewed, the number of sales associated with the video, and so on. The video information 760 collected by the machine learning model 790 can be used to update the user profile and the purchase intention of the user toward one or more products.

The illustration 700 includes implicit information 770. As the video chat progresses, the sales associate 720 can observe the user 710 and add implicit information to the machine learning model. Demographic information such as an estimated age, hair color, gender, personal style, general appearance, and so on can be added to the user profile. Information about the user's surroundings during the video chat can be added or used to estimate style or décor preferences, economic status, product preferences, hobbies, interests, and so on. Increasing or decreasing interest in the products being presented can be added based on eye contact, vocal inflections, questions or comments from the user, and so on. The sales associate can add an estimate of the user's likelihood of purchasing one or more items as the video chat continues.

The illustration 700 includes third party information 780. Third party information 780 can include data from additional user IDs associated with a user, information from other websites frequented by the user, search engines, user profile information available from vendors, and so on. Third party information can include purchase histories and searches related to brands, products, product categories, hobbies, interests, and so on. Website users who access a site via a search engine can have their search profile and associated information passed on to the website. The website user ID of the user can be matched with a user ID from one or more third party sources. Internet users with social media profiles can pass on attributes and data points from their user profiles to the websites they use for ecommerce, video viewing, and so on. Associations between user IDs on various sites can be recorded and used to gain additional data from third party websites to broaden a user profile and gain insight into purchase preferences, patterns, demographic information, tastes, lifestyle choices, and so on. All of this data, or select portions of the available data, can be added to an ecommerce website or social media platform database for analysis by a machine learning model.

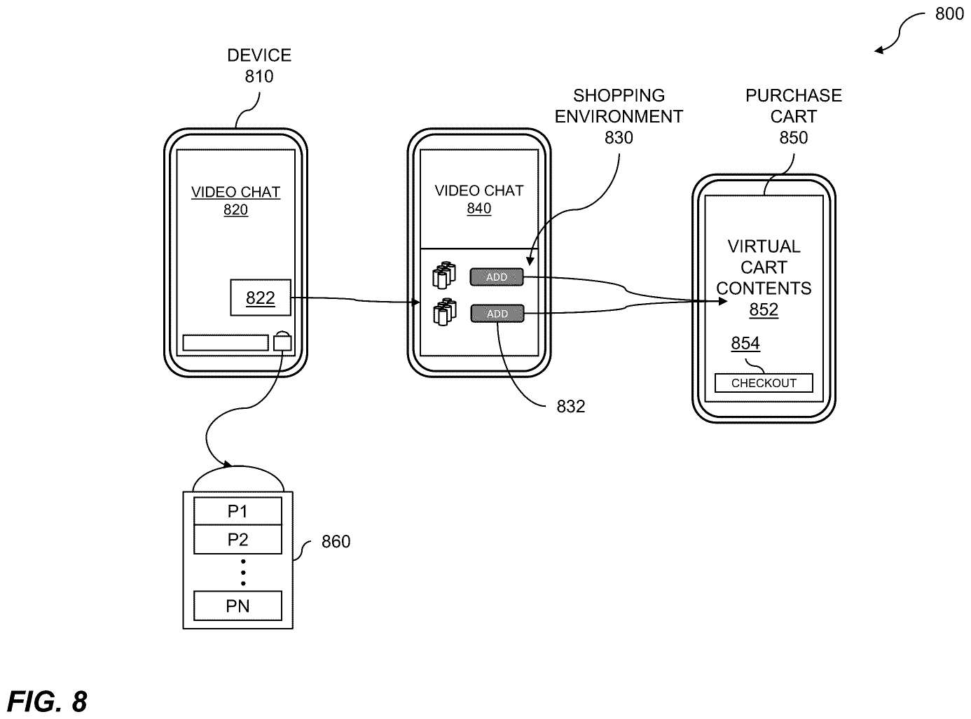

FIG. 8 shows an example of an ecommerce environment. As described above and throughout, a video chat can be rendered for one or more users. The video chat can highlight one or more products available for purchase. An ecommerce purchase can be enabled during the rendering of the video chat using an in-frame shopping environment. The in-frame shopping environment can allow internet connected television (CTV) users to buy products and services during the rendering of the video chat. The rendering can include an on-screen product card that can be viewed on a CTV device and a mobile device. The in-frame shopping environment or window can also include a virtual purchase cart that can be operated by users as the video chat continues.

The example 800 includes a device 810 displaying a video chat 820. In embodiments, the video chat 820 can be viewed in real time or replayed at a later time. The device 810 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the video chat 820 on the device 810 can be accomplished using a browser or another application running on the device.

The example 800 includes generating and revealing a product card 822 on the device 810. In embodiments, the product card represents at least one product available for purchase while the video chat plays. Embodiments can include inserting a representation of a product for sale into the on-screen product card. A product card is a graphical element such as an icon, thumbnail picture, thumbnail video, symbol, or other suitable element that is displayed in front of the livestream video. The product card is selectable via a user interface action such as a press, swipe, gesture, mouse click, verbal utterance, or other suitable user action. The product card 822 can be inserted when the video chat 840 is visible to the user. When the product card is invoked, an in-frame shopping environment 830 is rendered over a portion of the video chat while the video chat continues to play. This rendering enables an ecommerce purchase 832 by a user while preserving a continuous video chat session. In other words, the user is not redirected to another site or portal that causes the video chat session to stop. Thus, viewers are able to initiate and complete a purchase completely inside of the video chat user interface, without being redirected from the currently playing video chat. Allowing the video chat to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The example 800 includes rendering an in-frame shopping environment 830 enabling a purchase of the at least one product for sale by the viewer, wherein the ecommerce purchase is accomplished within the video chat window 840. In embodiments, the rendering of the video chat can include a real-time playing of the video chat 820 or a prerecorded video segment 840. The enabling can include revealing a virtual purchase cart 850 that supports checkout 854 of virtual cart contents 852, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 860 are purchased via product cards during the video chat, the purchases 850 are cached until termination of the video chat, at which point the orders are processed as a batch. The termination of the video chat can include the user stopping playback, the user exiting the video chat window, the video chat ending, or a prerecorded video ending. The batch order process can enable a more efficient use of computer resources, such as network bandwidth, by processing the orders together as a batch instead of processing each order individually.

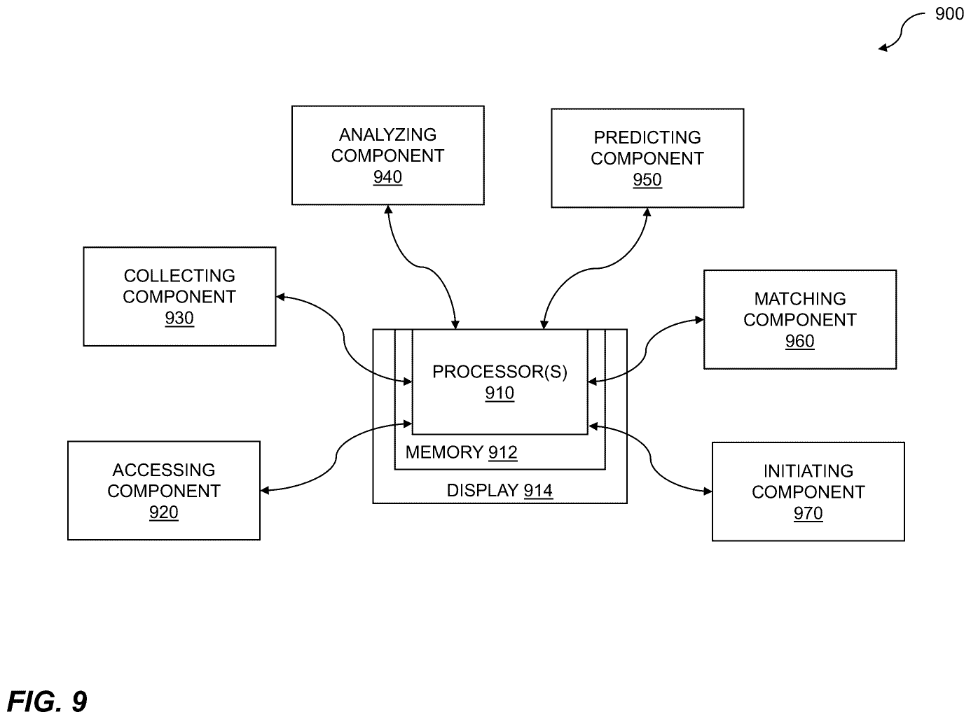

FIG. 9 is a system diagram for video chat initiation based on machine learning. The system 900 can include one or more processors 910 coupled to a memory 912 which stores instructions. The system 900 can include a display 914 coupled to the one or more processors 910 for displaying data, video streams, videos, intermediate steps, instructions, and so on. In embodiments, one or more processors 910 are coupled to the memory 912 where the one or more processors, when executing the instructions which are stored, are configured to: access a website, wherein the website includes one or more products for sale, wherein the website is viewed by a plurality of users; collect user information, using one or more processors, from the plurality of users viewing the website; analyze the user information, wherein the analyzing is based on machine learning; predict a purchase intention, for a user within the plurality of users, of the one or more products for sale, wherein the predicting is based on the analyzing, and wherein the predicting is based on machine learning; match the user with a sales associate from a plurality of sales associates, wherein the matching is based on the predicting; and initiate an interaction, in an overlay on the website, between the user and the sales associate.

The system 900 includes an accessing component 920. The accessing component 920 can include functions and instructions for accessing a website. In embodiments, the website includes one or more products for sale and is viewed by a plurality of users. Websites can be accessed by administrators, managers, programmers, sales representatives, and other staff working to maintain and configure the website. The staff members access the site with user IDs and passwords that grant elevated access to control panels, programming tools, product inventory, and so on. Users can access the website using internet connected laptops, desktops, pads, tablets, or mobile phones.

The system 900 includes a collecting component 930. The collecting component 930 can include functions and instructions for collecting user information, using one or more processors, from the plurality of users viewing the website. In embodiments, the user information includes one or more third party sources. The user information includes matching a user ID, of the user, with an ID from the one or more third party sources. The user information can include website history, chat text, voice interaction, or video usage information.

The system 900 includes an analyzing component 940. The analyzing component 940 can include functions and instructions for analyzing the user information, based on machine learning. In embodiments, the data collected from the website, from the user directly, from user performance on the website, and from third party sites and services in which the user participates can be placed into databases that can generate, test, and refine user profiles designed to predict user interests and intentions to purchase products and services.

The system 900 includes a predicting component 950. The predicting component 950 can include functions and instructions for predicting a purchase intention, for a user within the plurality of users, of the one or more products for sale. In embodiments, the predicting is based on the analyzing component 940, wherein the predicting is based on machine learning. The predicting component 950 includes a purchase intention for each user in the plurality of users. The predicting component 950 further comprises prioritizing the plurality of users, based on the purchase intention that was predicted. The predicting includes selecting, by the sales associate, one user from the plurality of users that was prioritized. Users can be segmented into groups based on products or groups of products in which the users have shown a level of interest. The purchasing intentions of each user in the group can be analyzed and predicted by the machine learning model, and the prediction can be used to rank the users in order of their likelihood of purchasing one or more products. The resulting list of users can be displayed to one or more sales associates in order of the strength of the user purchase intention. Sales associates can select a user from the list of users and can initiate contact, as described below.

The system 900 includes a matching component 960. The matching component 960 can include functions and instructions for matching the user with a sales associate from a plurality of sales associates. The matching is based on the predicting component 950. In embodiments, the matching component 960 includes gathering information about the plurality of sales associates. The sales associate information can include expertise, hobbies, appearance, conversion rate, tone, or style. The matching is based on the gathering information and machine learning. As user purchase intentions are analyzed, the users with the highest likelihood of purchasing a product can be matched with sales associates who match the users' interests, as well as having product knowledge for the items the user wants to buy. This increases the chance of the user completing the purchase. Users gathering information or focusing more specifically to investigate particular brands or types of products can be matched with sales associates who have strong corresponding product or brand knowledge, and so on.

The system 900 includes an initiating component 970. The initiating component 970 can include functions and instructions for initiating an interaction, in an overlay on the website, between the user and the sales associate. In embodiments, the interaction comprises a text chat or voice call. In embodiments, the interaction comprises a video chat. The video chat interaction can include a user sharing a screen with the sales associate. The video chat further comprises inviting, to the video chat, one or more additional users from within the plurality of users, based on the analyzing. In some embodiments, the video chat includes video of the sales associate only. The video chat further comprises showing, by the sales associate, information about the one or more products for sale. The video chat further comprises playing, by the sales associate, a short-form video to highlight the one or more products for sale. The video chat further comprises demonstrating, by the sales associate, the one or more products for sale. After a sales associate has been matched to a user, the sales representative can be notified and can be given details regarding the user and the products or services the user is investigating. The sales associate can then initiate contact with the user through the website. Chat questions and comments can help maintain user engagement as well as lead to discussions of additional products related to the product being displayed.

The initiating component 970 interaction between the user and the sales associate further comprises enabling, within the video chat, an ecommerce purchase of the one or more products for sale. In embodiments, the ecommerce purchase includes a virtual purchase cart. The ecommerce purchase further comprises displaying, within the video chat, the virtual purchase cart. In some embodiments, the virtual purchase cart covers a portion of the video chat. The ecommerce purchase further comprises representing the one or more products for sale in an on-screen product card. When the product card is invoked, an in-frame shopping environment is rendered over a portion of the video while the video continues to play. This rendering enables an ecommerce purchase by a user while preserving a continuous video playback session. Viewers are able to initiate and complete a purchase completely inside of the video playback user interface, without being redirected from the currently playing video or ongoing video chat. Allowing the video chat to play during the purchase can enable improved audience engagement, which can lead to additional sales and revenue, one of the key benefits of disclosed embodiments. The initiating component 970 further comprises providing the video chat to one or more third parties. The group video chats can be recorded and played back at a later time. These recorded chats can form the basis of a livestream event or can be presented on a third-party site as a way of marketing products on additional websites.

The system 900 can include a computer program product embodied in a non-transitory computer readable medium for video analysis, the computer program product comprising code which causes one or more processors to perform operations of: accessing a website, wherein the website includes one or more products for sale, wherein the website is viewed by a plurality of users; collecting user information, using one or more processors, from the plurality of users viewing the website; analyzing the user information, wherein the analyzing is based on machine learning; predicting a purchase intention, for a user within the plurality of users, of the one or more products for sale, wherein the predicting is based on the analyzing, and wherein the predicting is based on machine learning; matching the user with a sales associate from a plurality of sales associates, wherein the matching is based on the predicting; and initiating an interaction, in an overlay on the website, between the user and the sales associate.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video analysis comprising:
accessing a website, wherein the website includes one or more products for sale, wherein the website is viewed by a plurality of users;
collecting user information, using one or more processors, from the plurality of users viewing the website;
analyzing the user information, wherein the analyzing is based on machine learning;
predicting a purchase intention, for a user within the plurality of users, of the one or more products for sale, wherein the predicting is based on the analyzing, and wherein the predicting is based on machine learning;
matching the user with a sales associate from a plurality of sales associates, wherein the matching is based on the predicting; and
initiating an interaction, in an overlay on the website, between the user and the sales associate.

2. The method of claim 1 further comprising updating, from the interaction between the user and the sales associate, the user information.

3. The method of claim 2 wherein the user information includes website history, chat text, voice interaction, or video usage information.

4. The method of claim 2 wherein the user information includes implicit information, wherein the implicit information is gathered by the sales associate.

5. The method of claim 2 further comprising forming a shopper signal, for the sales associate, wherein the shopper signal indicates a probability of a sale by the user, and wherein the shopper signal is based on machine learning.

6. The method of claim 2 further comprising rematching the user with another sales associate, wherein the rematching is based on the collecting, and wherein the rematching is based on machine learning.

7. The method of claim 1 further comprising gathering information about the plurality of sales associates.

8. The method of claim 7 wherein the gathering information includes expertise, hobbies, appearance, conversion rate, tone, or style.

9. The method of claim 8 wherein the matching is based on the gathering information, and wherein the matching is further based on machine learning.

10. The method of claim 1 wherein the interaction comprises a text chat or voice call.

11. The method of claim 1 wherein the interaction comprises a video chat.

12. The method of claim 11 further comprising inviting, to the video chat, one or more additional users from within the plurality of users, wherein the inviting is based on the analyzing.

13. The method of claim 11 wherein the video chat includes video of the sales associate only.

14. The method of claim 11 further comprising sharing a screen, by the user, with the sales associate.

15. The method of claim 14 further comprising showing, by the sales associate, information about the one or more products for sale.

16. The method of claim 14 further comprising playing, by the sales associate, a short-form video to highlight the one or more products for sale to the user.

17. The method of claim 14 further comprising demonstrating, by the sales associate, the one or more products for sale.

18. The method of claim 11 further comprising enabling, within the video chat, an ecommerce purchase of the one or more products for sale.

19. The method of claim 11 further comprising providing the video chat to one or more third parties.

20. The method of claim 1 wherein the predicting includes a purchase intention for each user in the plurality of users.

21. The method of claim 20 further comprising prioritizing the plurality of users, wherein the prioritizing is based on the purchase intention that was predicted.

22. The method of claim 21 further comprising selecting, by the sales associate, one user from the plurality of users that was prioritized.

23. The method of claim 1 further comprising matching a user ID, of the user, with an ID from one or more third party sources.

24. The method of claim 1 wherein the user views a database supporting the website directly on a mobile device application.

25. A computer program product embodied in a non-transitory computer readable medium for video analysis, the computer program product comprising code which causes one or more processors to perform operations of:
accessing a website, wherein the website includes one or more products for sale, wherein the website is viewed by a plurality of users;
collecting user information, using one or more processors, from the plurality of users viewing the website;
analyzing the user information, wherein the analyzing is based on machine learning;
predicting a purchase intention, for a user within the plurality of users, of the one or more products for sale, wherein the predicting is based on the analyzing, and wherein the predicting is based on machine learning;
matching the user with a sales associate from a plurality of sales associates, wherein the matching is based on the predicting; and
initiating an interaction, in an overlay on the website, between the user and the sales associate.

26. A computer system for video analysis, comprising:
a memory which stores instructions;
one or more processors attached to the memory wherein the one or more processors, when executing the instructions which are stored, are configured to:
access a website, wherein the website includes one or more products for sale, wherein the website is viewed by a plurality of users;
collect user information, using one or more processors, from the plurality of users viewing the website;
analyze the user information, wherein the analyzing is based on machine learning;
predict a purchase intention, for a user within the plurality of users, of the one or more products for sale, wherein the predicting is based on the analyzing, and wherein the predicting is based on machine learning;
match the user with a sales associate from a plurality of sales associates, wherein the matching is based on the predicting; and
initiate an interaction, in an overlay on the website, between the user and the sales associate.
